(19) United States
(12) Patent Application Publication
(10) Pub. No.: US 2009/0230281 A1
(43) Pub. Date: Sep. 17, 2009

(54) MOLD WITH UNLOADING MECHANISM

(75) Inventors: Chih-Yu CHEN, Taipei Hsien (TW); Jian-Guang HUANG, Taipei Hsien (TW); Chun-Yan WU, Taipei Hsien (TW); Guo-Ning LIANG, Taipei Hsien (TW)

Correspondence Address: WPAT, PC;INTELLECTUAL PROPERTY ATTORNEYS, 2030 MAIN STREET, SUITE 1300, IRVINE, CA, 92614, US

(73) Assignee: CHENG UEI PRECISION INDUSTRY CO., LTD., Taipei Hsien (TW)

(21) Appl. No.: 12/050,115

(22) Filed: Mar. 17, 2008

(51) Int. Cl. B30B 15/02

(52) U.S. Cl. 249/68

(57) ABSTRACT

A mold with unloading mechanism includes an upper insert embedded in an upper plate, a lower insert embedded in a lower plate and matching the upper insert to define a cavity therebetween for molding the product, a bottom clamping plate located under the lower plate via a padding plate, a pusher penetrating through the bottom clamping plate to push an ejector plate assembly movably received in the padding plate, two unloading pins, a stroke pin and an elastic element. The bottom of the unloading pin is fixed in the ejector plate assembly and the bottom of the stroke pin is movably configured in the ejector plate assembly. The top of the unloading pin and the stroke pin movably penetrates through the lower plate and the lower insert to push the product. The elastic element is against the bottom clamping plate and the bottom of the stroke pin.

### BACKGROUND OF THE INVENTION

1. Field of the Invention

The present invention generally relates to a mold, and more particularly to a mold with unloading mechanism.

2. The Related Art

Traditionally, some products, such as a product 100 shown in FIG. 1, are unloaded by twice ejecting after injection molding. Referring to FIG. 2, a traditional mold with unloading mechanism used to mold and unload the product 100 is shown. The mold with unloading mechanism includes a lower plate 51, a lower insert 52, a padding plate 53, a bottom clamping plate 54 and an unloading mechanism. The lower insert 52 is embedded in the lower plate 51 and matches with an upper insert 61 embedded in an upper plate 62 to define a cavity (not shown) therebetween for molding the product 100. The padding plate 53 is located under the lower plate 51 and defines a space 531 penetrating from top to bottom. The padding plate 53 further defines a preventing portion 532 stretching into the space 531 at the top. The bottom clamping plate 54 is fixed under the padding plate 53. The unloading mechanism comprises an ejector plate assembly 55, a stroke plate 56 located under the ejector plate assembly 55, a pusher 57, a stroke pin 58, two unloading pins 59 and a connecting part 50 connecting with the ejector plate assembly 55 and the stroke plate 56. The bottom of the connecting part 50 is fixed in the stroke plate 56 and the top thereof can freely open and close and is inserted in the ejector plate assembly 55. The ejector plate assembly 55 and the stroke plate 56 are movably received in the space 531 and the stroke plate 56 is restricted by the preventing portion 532. The top of the pusher 57 penetrates through the stroke plate 56 to push the ejector plate assembly 55. The bottom of the pusher 57 passes through the bottom clamping plate 54 to stretch out of the bottom of the bottom clamping plate 54. The bottom of the unloading pin 59 is fixed in the ejector plate assembly 55 and the top thereof penetrates through the lower plate 51 and the lower insert 52 to push the product 100. The bottom of the stroke pin 58 is fixed in the stroke plate 56 and the top thereof protrudes upward to form a shaping section 581. The shaping section 581 penetrates through the ejector plate assembly 55, the lower plate 51 and the lower insert 52 to stretch into the cavity for molding a corresponding region of the product 100.

When the mold with unloading mechanism is opened after injection molding, the pusher 57 pushes the ejector plate assembly 55 to move upward and further drives the stroke plate 56 to move upward by the connecting part 50. The ejector plate assembly 55 and the stroke plate 56 respectively drive the unloading pin 59 and the stroke pin 58 to move upward. When the stroke plate 56 abuts against the preventing portion 532, the stroke plate 56 stops moving upward. At this moment, the product 100 and the shaping section 581 stretch out of the cavity. When the pusher 57 continues pushing the ejector plate assembly 55 to move upward, because the stroke plate 56 stops moving upward, the top of the connecting part 50 is opened by the thrust of the pusher 57 to make the ejector plate assembly 55 isolated from the stroke plate 56. Then, the ejector plate assembly 55 continues moving upward and further drives the unloading pin 59 to move upward to further push the product 100. At this moment, the region of the product 100 in accordance with the shaping section 581 of the stroke pin 58 is actuated by the thrust of the unloading pin 59 to open under the self-elasticity so as to strip off the shaping section 581. So far, the product 100 is completely unloaded from the mold with unloading mechanism. When the mold with unloading mechanism is closed, the pusher 57 moves downward to pull the ejector plate assembly 55 and the unloading pin 59 to move downward. In the process of the ejector plate assembly 55 moving downward, the top of the connecting part 50 is gradually closed to make the stroke plate 56 connected with the ejector plate assembly 55 to move downward together. The stroke plate 56 further drives the stroke pin 58 to reposition.

The above-mentioned mold with unloading mechanism utilizes the cooperation of the stroke plate 56, the connecting part 50 and the preventing portion 532 to twice eject the product 100. However, the stroke plate 56, the connecting part 50 and the preventing portion 532 have a complicated structure to be processed difficultly and occupy a large space so that it is unsuitable to process a smaller product.

### SUMMARY OF THE INVENTION

An object of the present invention is to provide a mold with unloading mechanism, which has a simpler structure and occupies a smaller space.

The mold with unloading mechanism adapted for molding a product whose unloading from the mold needs to be ejected twice includes an upper plate with an upper insert embedded therein, a lower plate, a lower insert, a padding plate under the lower plate, a bottom clamping plate and an unloading mechanism. The lower plate matches with the upper plate and defines at least one preventing hole and at least one first perforation therethrough. The lower insert is embedded in the lower plate and matches with the upper insert to define a cavity therebetween for molding the product. The lower insert defines at least one insert hole and at least one second perforation respectively matching with the preventing hole and the first perforation. The bottom clamping plate is located under the padding plate and defines an aperture therethrough. The unloading mechanism includes an ejector plate assembly, a pusher, at least one unloading pin, at least one stroke pin and an elastic element. The ejector plate assembly is movably received in the padding plate and defines a stroke hole at the top thereof and a receiving groove connecting the stroke hole at the bottom thereof. A shoulder is formed at the junction of the stroke hole and the receiving groove. The top of the pusher passes through the aperture of the bottom clamping plate for pushing the ejector plate assembly. The bottom of the unloading pin is fixed in the ejector plate assembly and the top of the unloading pin passes through the first perforation of the lower plate and the second perforation of the lower insert for pushing the product. The stroke pin has a restricting section received in the receiving groove and restricted by the shoulder. A preventing section extends upward from the restricting section and is movably received in the stroke hole and restricted by the preventing hole of the lower plate. The preventing section extends upward to form an ejector section. The top of the ejector section passes through the preventing hole of the lower plate and the insert hole of the lower insert for pushing the product. One end of the elastic element is received in the receiving groove and abuts against the restricting section. The other end of the elastic element stretches out of the receiving groove and is against the bottom clamping plate.

As described above, the mold with unloading mechanism of the present invention utilizes the elastic element, the preventing section and the restricting section which have a simpler structure and occupy a smaller space instead of a stroke plate, a connecting part and a preventing portion of a traditional mold with unloading mechanism which have a complicated structure and occupy a large space. Therefore, the mold with unloading mechanism of the present invention has a simpler structure to be processed easily and occupies a smaller space so that a smaller product can be processed therein.

### BRIEF DESCRIPTION OF THE DRAWINGS

The present invention will be apparent to those skilled in the art by reading the following description of a preferred embodiment thereof, with reference to the attached drawings, in which:

FIG. 1 is a partially cutaway perspective view of a product, whose unloading needs to be ejected twice;

FIG. 2 is a cross-sectional view of a traditional mold with unloading mechanism which is closed;

FIG. 3 is a cross-sectional view of a mold with unloading mechanism in accordance with the present invention, wherein the mold with unloading mechanism is closed;

FIG. 4 is a cross-sectional view of the mold with unloading mechanism of FIG. 3 without unloading pins, a stroke pin, a spring, a locating bar and a screw;

FIG. 5 is a cross-sectional view of the mold with unloading mechanism of FIG. 3, which is lying in the state of the first ejecting; and

FIG. 6 is a cross-sectional view of the mold with unloading mechanism of FIG. 3, which is lying in the state of the second ejecting.

### DETAILED DESCRIPTION OF THE PREFERRED EMBODIMENT

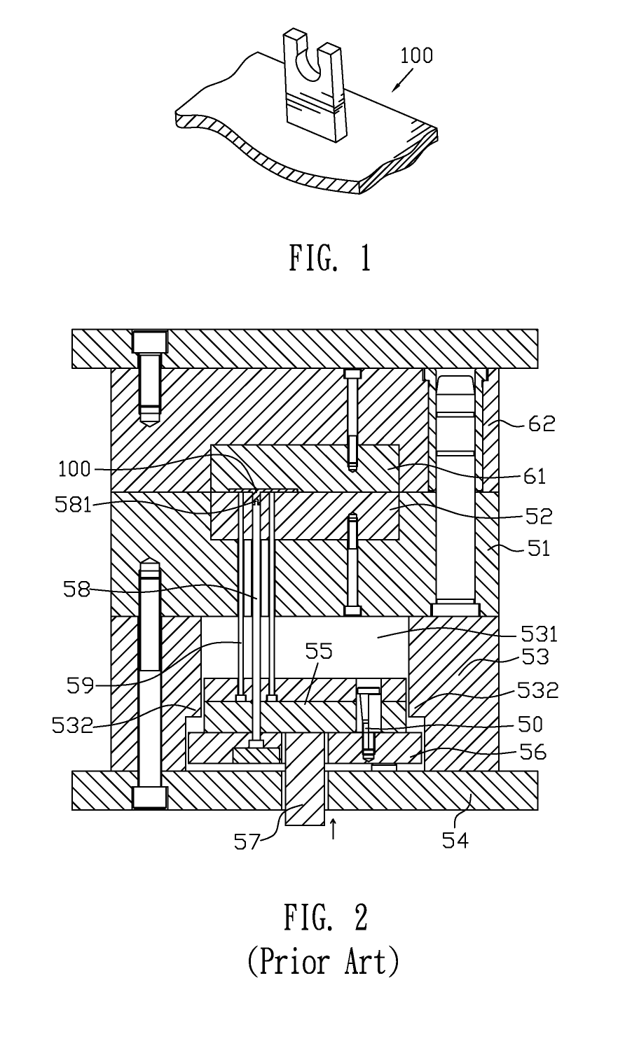

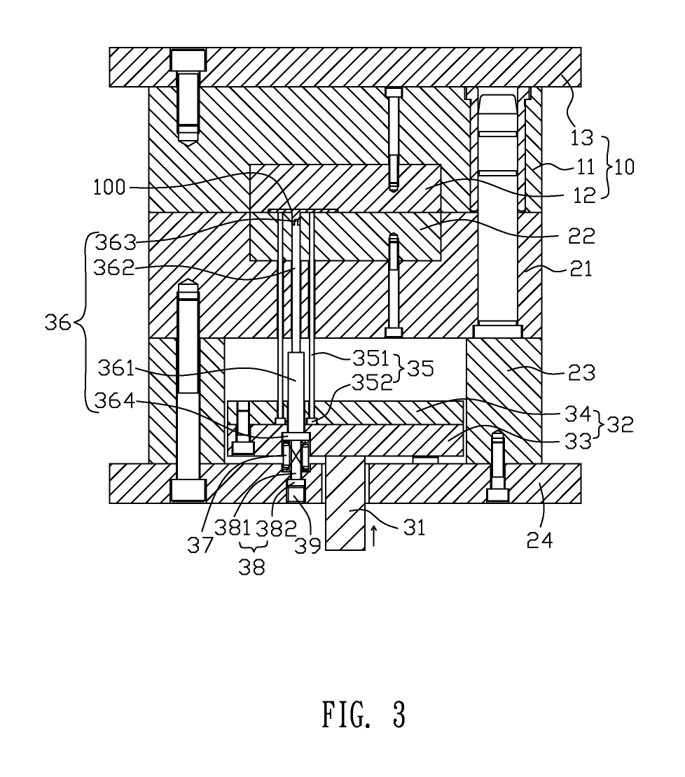

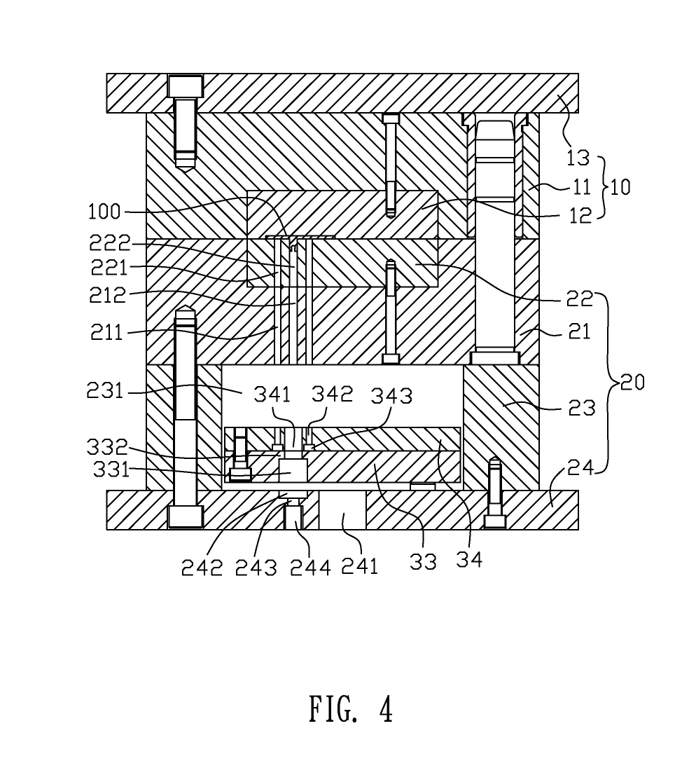

With reference to FIG. 3 and FIG. 4, a mold with unloading mechanism in accordance with the present invention is adapted for molding a product 100 shown in FIG. 1. The mold with unloading mechanism includes an upper assembly 10, a lower assembly 20 located under the upper assembly 10 and an unloading mechanism configured in the lower assembly 20.

Referring to FIG. 4, the upper assembly 10 includes an upper plate 11, an upper insert 12 embedded in the bottom of the upper plate 11 and a top clamping plate 13 fixed on the top of the upper plate 11. The lower assembly 20 includes a lower plate 21, a lower insert 22, a padding plate 23 and a bottom clamping plate 24. The lower insert 22 is embedded in the top of the lower plate 21 and matches with the upper insert 12 to define a cavity therebetween (not shown). The lower insert 22 vertically defines two cylindrical second perforations 221 and a cylindrical insert hole 222 located between the two second perforations 221. The top of the second perforation 221 and the insert hole 222 communicates with the cavity and the bottom thereof penetrates through the bottom of the lower insert 22. The lower plate 21 vertically defines two first perforations 211 and a preventing hole 212 respectively matching and connecting the corresponding second perforations 221 and the insert hole 222. The padding plate 23 is located under the lower plate 21 and defines a space 231 penetrating from top to bottom. The bottom of the first perforations 211 and the preventing hole 212 communicates with the space 231. The bottom clamping plate 24 is fixed under the padding plate 23 and vertically defines an aperture 241 penetrating from top to bottom and communicating with the space 231. The top of the bottom clamping plate 24 defines a cylindrical fillister 242 facing to the preventing hole 212 of the lower plate 21. The diameter of the fillister 242 is greater than the diameter of the preventing hole 212. The bottom of the bottom clamping plate 24 defines a cylindrical screw hole 244 connected with the bottom of the fillister 242 via a smaller cylindrical channel 243.

Referring to FIGS. 3 and 4, the unloading mechanism includes a pusher 31 extending vertically, an ejector plate assembly 32, two unloading pins 35, a stroke pin 36, a spring 37, a locating bar 38 and a screw 39. The ejector plate assembly 32 is received in the space 231 of the padding plate 23 and can move upward or downward. The ejector plate assembly 32 comprises a bottom ejector plate 33 and a top ejector plate 34 fixed on the top of the bottom ejector plate 33. The bottom of the bottom ejector plate 33 defines a cylindrical receiving groove 331 matching with the fillister 242 of the bottom clamping plate 24. The top ejector plate 34 defines a cylindrical stroke hole 341 connecting the top of the receiving groove 331 and facing to the preventing hole 212 of the lower plate 21. The diameter of the stroke hole 341 is greater than the diameter of the preventing hole 212 and smaller than the diameter of the receiving groove 331. A shoulder 332 is formed at the junction of the stroke hole 341 and the receiving groove 331. The bottom of the top ejector plate 34 defines two fixing grooves 343 respectively located at two sides of the stroke hole 341. The middle of the top of the fixing groove 343 extends upward to penetrate through the top ejector plate 34 for forming a connecting hole 342 matching with the corresponding first perforation 211 of the lower plate 21. The top of the pusher 31 is fixed on the bottom of the bottom ejector plate 33 and the bottom of the pusher 31 stretches out of the aperture 241 of the bottom clamping plate 24.

The unloading pin 35 has a cylindrical ejector body 351 extending vertically. The bottom of the ejector body 351 protrudes outward to form a fixing block 352 fixed in the fixing groove 343. The top of the ejector body 351 passes through the connecting hole 342, the first perforation 211 and the second perforation 221 to abut against the bottom of the product 100 molded in the cavity. The stroke pin 36 has a cylindrical restricting section 364 movably received in the receiving groove 331 and restricted by the shoulder 332. The middle of the top of the restricting section 364 extends upward to form a cylindrical preventing section 361 passing through the stroke hole 341 to stretch into the space 231. The middle of the top of the preventing section 361 extends upward to form a cylindrical ejector section 362 movably received in the preventing hole 212 and the insert hole 222. The top of the ejector section 362 protrudes upward to form a shaping section 363 stretching into the cavity to mold a corresponding region of the product 100. The spring 37 is compressed and configured in the receiving groove 331 and the fillister 242. The top of the spring 37 abuts against the restricting section 364. The locating bar 38 has a locking block 382 received in the screw hole 244. The top of the locking block 382 extends upward to form a locating portion 381 passing through the channel 243 to insert into the spring 37 for preventing the spring 37 slanting. The screw 39 is configured in the screw hole 244 to abut against the locking block 382 for fixing the locating bar 38.

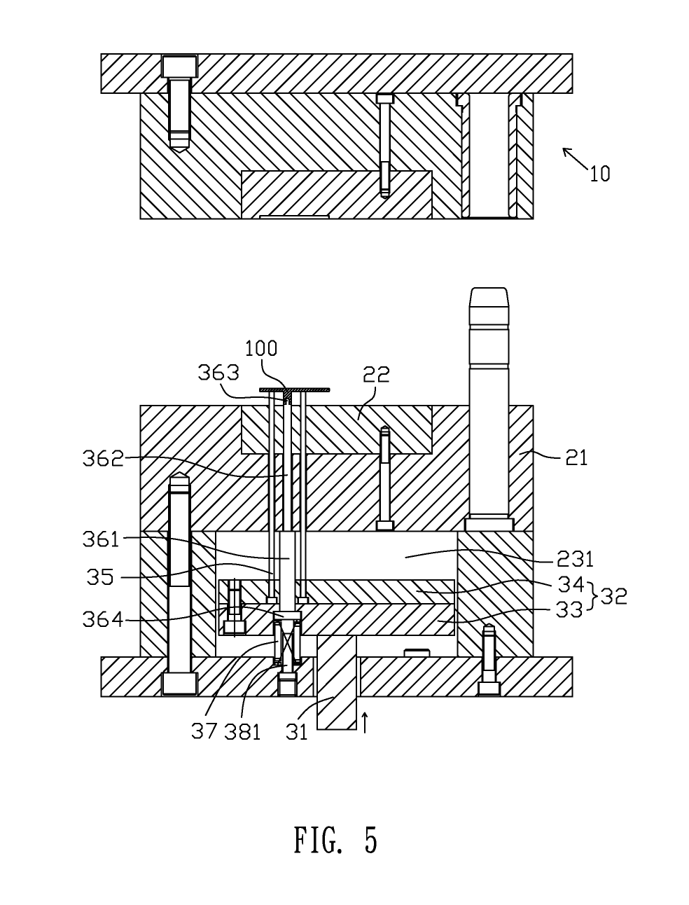

Referring to FIG. 5, when the mold with unloading mechanism is opened after injection molding, the upper assembly 10 moves upward. The pusher 31 pushes the ejector plate assembly 32 to move upward in the space 231 and further drives the unloading pin 35 to move upward. At the same time, the stroke pin 36 is driven by the elasticity of the spring 37 to move upward with the ejector plate assembly 32. When the top of the preventing section 361 of the stroke pin 36 abuts against the bottom of the lower plate 21, the stroke pin 36 stops moving upward. At this moment, the shaping section 363 and the product 100 stretch out of the cavity.

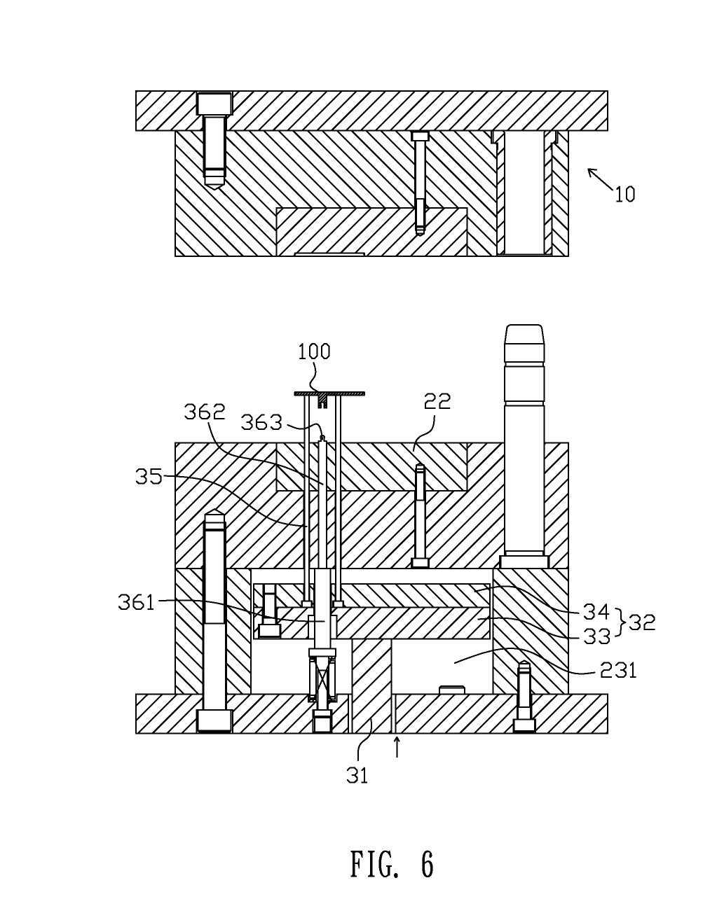

Referring to FIG. 6, when the stroke pin 36 stops moving upward, the pusher 31 continues pushing the ejector plate assembly 32 to move upward and further driving the unloading pin 35 to continue moving upward to further push the product 100. At this moment, because the stroke pin 36 stops moving, the region of the product 100 in accordance with the shaping section 363 is actuated by the thrust of the unloading pin 35 to open under the self-elasticity so as to strip off the shaping section 363. So far, the product 100 is completely unloaded from the mold with unloading mechanism.

When the mold with unloading mechanism is closed, the pusher 31 moves downward to pull the ejector plate assembly 32 and the unloading pin 35 to moving downward. When the shoulder 332 of the bottom ejector plate 33 abuts against the restricting section 364 of the stroke pin 36, the shoulder 332 pushes the restricting section 364 downward to drive the stroke pin 36 to move downward with the ejector plate assembly 32. At the same time, the restricting section 364 compresses the spring 37 along the locating portion 381 of the locating bar 38 to make the spring 37 in the state of being compressed again. At last, the upper assembly 10 moves downward to abut against the top of the lower assembly 20.

As described above, the mold with unloading mechanism of the present invention utilizes the spring 37, the preventing section 361 and the restricting section 364 which have a simpler structure and occupy a smaller space instead of a stroke plate 56, a connecting part 50 and a preventing portion 531 (as shown in FIG. 2) which have a complicated structure and occupy a large space. Therefore, the mold with unloading mechanism of the present invention has a simpler structure to be processed easily and occupies a smaller space so that a smaller product can be processed therein.

What is claimed is:

1. A mold with unloading mechanism adapted for molding a product whose unloading from the mold needs to be ejected twice, the mold with unloading mechanism comprising:
an upper plate with an upper insert embedded therein;
a lower plate matching with the upper plate, the lower plate defining at least one preventing hole and at least one first perforation therethrough;
a lower insert embedded in the lower plate and matching with the upper insert to define a cavity therebetween for molding the product, the lower insert defining at least one insert hole and at least one second perforation respectively matching with the preventing hole and the first perforation;
a padding plate under the lower plate;
a bottom clamping plate under the padding plate and defining an aperture therethrough; and
an unloading mechanism having
an ejector plate assembly movably received in the padding plate and defining a stroke hole at a top thereof and a receiving groove connecting the stroke hole at a bottom thereof, a shoulder being formed at the junction of the stroke hole and the receiving groove,
a pusher, a top of the pusher passing through the aperture of the bottom clamping plate for pushing the ejector plate assembly,
at least one unloading pin, a bottom of the unloading pin being fixed in the ejector plate assembly and a top of the unloading pin passing through the first perforation of the lower plate and the second perforation of the lower insert for pushing the product,
at least one stroke pin having a restricting section received in the receiving groove and restricted by the shoulder, a preventing section extending upward from the restricting section and being movably received in the stroke hole and being restricted by the preventing hole of the lower plate, the preventing section extending upward to form an ejector section, a top of the ejector section passing through the preventing hole of the lower plate and the insert hole of the lower insert for pushing the product, and
an elastic element, one end of the elastic element being received in the receiving groove and abutting against the restricting section, the other end of the elastic element stretching out of the receiving groove and being against the bottom clamping plate.

2. The mold with unloading mechanism as claimed in claim 1, wherein a top of the bottom clamping plate defines a fillister matching with the receiving groove, a bottom of the elastic element is received in the fillister.

3. The mold with unloading mechanism as claimed in claim 1, wherein the elastic element is a spring.

4. The mold with unloading mechanism as claimed in claim 3, wherein the unloading mechanism further includes a locating bar and a screw, the locating bar has a locking block and a locating portion extending upward from a top of the locating portion, a bottom of the bottom clamping plate defines a screw hole connected with the fillister via a channel, the locking block is received in the screw hole and the locating portion passes through the channel to insert into the spring, the screw is configured in the screw hole and abuts against the locking block.
